(19) United States
(12) Patent Application Publication
(10) Pub. No.: US 2007/0174045 A1
(43) Pub. Date: Jul. 26, 2007

(54) Automatic acronym expansion using pop-ups

(75) Inventors: Sandy Kao, Austin, TX (US); Arif Kasim, San Antonio, TX (US); Rodrigo J. Pastrana, Delray Beach, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/339,155

(22) Filed: Jan. 25, 2006

(51) Int. Cl. G06F 17/28

(52) U.S. Cl. 704/4

(57) ABSTRACT

A method for automatically defining acronyms can include a step of a user receiving an electronic communication. The electronic communication can include text. The text can include at least one acronym. The text can be displayed within a graphical user interface (GUI) viewable by the user. A positioning of a pointer proximate to the displayed acronym can be detected. A pop-up can be automatically presented. The pop-up can include an expansion of the displayed acronym.

### BACKGROUND

1. Field of the Invention

The present invention relates to the field of computer software and, more particularly, to software that automatically expands acronyms using pop-ups.

2. Description of the Related Art

A culture of acronym usage has developed among electronic communicators, which can be befuddling to the newly indoctrinated. The use of these acronyms is so widespread and routine that those communicators not knowing common acronyms are stigmatized or unable to properly participate in communications. For example, most instant messaging (IM) and chat users know the meaning of the following acronyms: “be right back” (brb), “laugh out loud” (lol), “thank you” (ty), and “you're welcome” (yw). Acronyms are constantly being incorporated into a growing text messaging language.

Additionally, groups of people commonly exchanging IM communications or participating in topic specific chat forums develop group or forum specific acronyms. For example, a husband and wife who exchange IM messages may develop an acronym for “Hi honey, how are you?” (HHHY), which might receive a response of “same stuff, different day, you?” (SSDD U), “the boss is here, will talk later” (BHTL), or “couldn't be better” (CBB). For some people, the use of common or group specific acronyms for electronic communication becomes so routine that they often assume that everyone else knows what the acronyms mean.

Further, text acronym usage can be particularly beneficial/addictive for text message users sending messages from mobile devices, such as smart phones or BLACKBERRY devices. These mobile devices usually have tiny keyboards that make typing full words and phases difficult. Hence, many mobile devices using text messaging often use acronym shorthand notation when communicating. Conventional electronic communication applications fail to help users decipher unknown acronyms.

### SUMMARY OF THE INVENTION

The present invention includes a method for automatically expanding acronyms within a graphical user interface (GUI). More specifically, the method can present an acronym expansion in a pop-up positioned near the corresponding acronym, where the pop-up can be a small window positioned on top of a window in which the text for the acronym is displayed. In one embodiment, the pop-up can be implemented as a fly-over pop-up, meaning that it automatically appears if a pointer is centered over an acronym for a designated time. The pop-up can automatically disappear whenever the previously stationary pointer is repositioned. Additionally, a visual indicator can be used to inform a GUI user that an expansion for an acronym is available. A user configurable acronym expansion repository can be used to match acronyms with expansions. In one embodiment, expansions for acronyms defined by a communication participant can be automatically provided to other communication participants.

The present invention can be implemented in accordance with numerous aspects consistent with material presented herein. For example, one aspect of the present invention can include a method for automatically defining acronyms. The method can include a step of a user receiving an electronic communication. The electronic communication can include text. The text can include at least one acronym. The text can be displayed within a graphical user interface (GUI) viewable by the user. A positioning of a pointer proximate to the displayed acronym can be detected. A pop-up can be automatically presented. The pop-up can include an expansion of the displayed acronym.

Another aspect of the present invention includes a system for exchanging text messages. The system can include a communication server, an acronym expansion repository, a messaging processing engine, and a communication interface. The communication server can manage communication sessions between remotely located communication participants. The communication sessions can be configured to permit an exchange of text messages. The acronym expansion repository can include one or more acronyms and corresponding expansions. The messaging processing engine can automatically detect when acronyms included within the acronym expansion repository are included within text messages. The communication interface can be used by one of the communication participants. The communication interface can include a participant activatable option for automatically presenting an expansion from the acronym expansion repository for an acronym textually displayed within the communication interface.

Yet another aspect of the present invention can include a graphical user display (GUI) in which acronym expansions are presented. The GUI can include an application window, and expansion indicator, and a pop-up. The application window can include a text display area, wherein at least one acronym is displayed in the text display area The expansion indicator can be displayed in the text display area proximately positioned to the acronym. A presence of the expansion indicator indicates to a user that an expansion is available for the acronym. The pop-up can be displayed on top of the application window. The pop-up can display an expansion for the acronym.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system 100 for expanding acronyms within a graphical user interface in accordance with an embodiment of the inventive arrangements described herein.

FIG. 2 is a schematic diagram of a GUI having acronym expansion features in accordance with an embodiment of the inventive arrangements disclosed herein.

FIG. 3 is a flow chart of a method for automatically defining acronyms in accordance with an embodiment of the inventive arrangements disclosed herein.

### DETAILED DESCRIPTION OF THE INVENTION

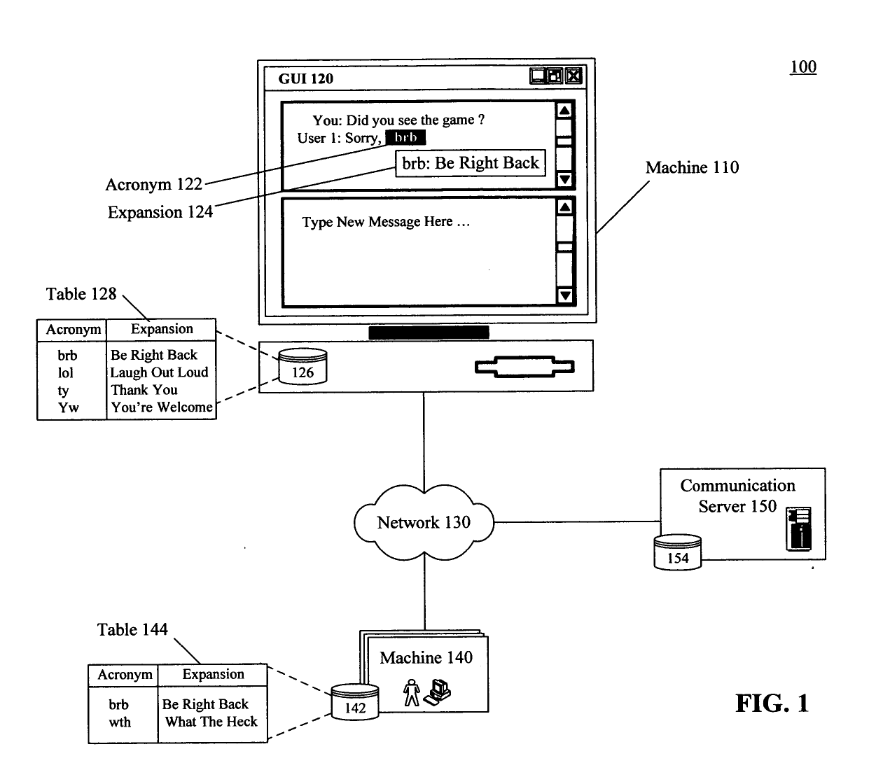

FIG. 1 is a schematic diagram of a system 100 for expanding acronyms within a graphical user interface (GUI) in accordance with an embodiment of the inventive arrangements described herein. The system 100 can include a machine 110, a machine 140, and a communication server 150 communicatively linked via network 130.

Machine 110 can include a GUI 120 for online communications. GUI 120 can textually display one or more acronyms 122. Each of these acronyms can be defined or expanded within an expansion pop-up 124. The expansion pop-up 124 can selectively be activated/deactivated whenever a displayed acronym 122 has a previously defined expansion.

Through GUI 120, a user of machine 110 can exchange text messages with a user of machine 140. The text messages can be directly conveyed between machine 110 and machine 140, which is a common arrangement for instant messaging (IM) communications. The text messages can also be conveyed though a communication server 150, which is common for chat based communications.

Content included within expansion pop-up 124 can be retrieved from one or more data stores, including data store 126, 154, and 142. For example, data store 126 can include a user configurable acronym definition table 128. As illustrated, table 128 can provide expansions for acronyms: “be right back” (brb), “laugh out loud” (lol), “thank you” (ty), and “you're welcome” (yw).

Similarly, data store 142 can include another acronym definition table 144, which can contain acronyms defined by a user of machine 140. Table 144 can provide expansions for acronyms: “be right back” (brb), and “what the heck” (wth).

When text messages are exchanged between machine 110 and 144, both machines can use acronyms defined within table 128 and 144. In one embodiment, if the same acronym appears in both table 128 and table 144, the selected table for determining the acronym's expansion can be the table associated with the message writer.

Consequently, if a user of machine 140 sends acronym “brb” to machine 110, machine 110 can use table 144 to determine an expansion for “brb.” The opposite is also true. That is, if a user of machine 110 sends acronym “brb” to machine 140, machine 140 can use table 128 to determine an expansion for “brb.” Additionally expansions for acronyms can be included in data store 154, which can be used during any text messaging session involving communication server 150. Further, a remote data store not specifically associated with machine 110, machine 140, or server 150 that defines acronyms and their expansions can be utilized.

Tables 128 and/or 144 used to define acronym expansions can be shared among users in any of a variety of different manners. For example, when a communication is initialized between machine 110 and 140, a temporary copy of each machine's expansion lists can be exchanged. Thus, machine 110 can receive a temporary copy of table 144 and machine 140 can receive a temporary copy of table 128.

In another example, communication server 150 can dynamically create a communication session acronym table for a communication session including machine 110 and machine 140 from a server specific table in data store 154 and from entries contained within table 128 and table 144. When messages are exchanged through the communication server 150, a text processor (not shown) can locate any acronyms contained within the messages and can include expansions for those acronyms when providing the text message to desired recipients. For instance, when extensible Markup Language (XML) based messages are used to convey chat messages from the communication server 150 to machines 110 and 140, expansions for chat message acronyms can be defined within a data field of the XML based message.

In yet another example, whenever a text message including an acronym having an expansion defined in table 144 is exchanged between machine 140 and machine 110, machine 140 can also convey the expansion to machine 110. Such an implementation can require machine 140 to preprocess text to determine acronym expansions within the text before the messages are conveyed.

In still another embodiment, each message receiving machine can be responsible for processing text for acronyms. This processing can occur at the time that text is received or displayed. The processing can also occur “on demand” after a user of the machine has requested an expansion for a user selected acronym. Regardless of when text processing occurs, a message receiving machine can submit queries to remotely located data stores for expansions for acronyms not locally defined.

Thus, machine 110 can send a query to machine 140 and/or server 150 that requests an expansion for acronym “wth.” Machine 140 can provide an expansion “what the heck” from table 144 to machine 110 in response to the query.

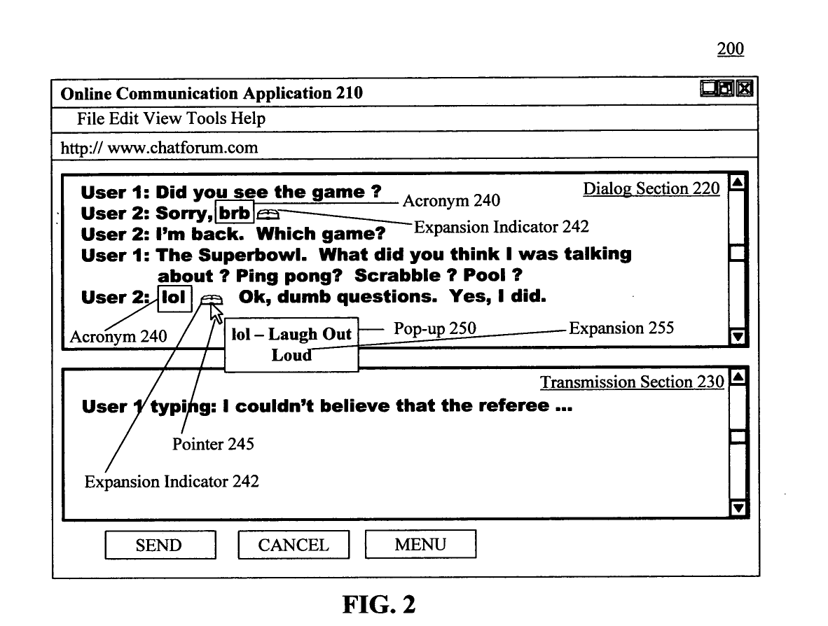

FIG. 2 is a schematic diagram of a GUI 200 having acronym expansion features in accordance with an embodiment of the inventive arrangements disclosed herein. GUI 200 can be one instance of GUI 120. GUI 200 is not to be construed as limited to the precise details and arrangements shown, but is intended to encompass alternative interface presentation options, visual elements, triggers, and the like. Thus, GUI 200 is intended to illustrate an interface concept and interface derivatives for implementing the concept shown by GUI 200 are contemplated.

GUI 200 can include an online communication application 210 within which a text based online dialog occurs. The online communication application 210 can include an instant messaging (IM) application, an online chat application, a teleconferencing application, and the like. Online communication application 210 is not limited to a dedicated communication application, but can instead include any application where communications are graphically presented. For example, online communication application 210 can include an interactive computer game, where players are able to communicate with one another via text messages. In another example, online communication application 210 can be an email client.

As illustrated in system 200, the online communication application 210 includes a dialog section 220 and a transmission section 230. The dialog section 220 is a GUI section, where a user can view a textual dialog. The dialog section 220 can denote users responsible for particular comments and a time at which each comment was made. The transmission section 230 is a GUI section where a user can type new messages.

Acronyms 240 appearing within the dialogue section 220 can be processed to determine if an expansion for that acronym is available. When an expansion is available, an expansion indicator 242 can be displayed. The expansion indicator 242 can include an icon, a highlighting, a text color change, a text style change, and any other user noticeable visual indicator.

Pop-up 250 can be an overlay window or dialog box that includes expansion 255. Expansion 255 can be a textual expansion or textual definition for an associated acronym. Pop-up 250 can also include additional items related to the expansion 255, such as repeating text for the acronym being expanded (shown), providing user triggerable links or icons to modify/delete/view an acronym expansion repository (not shown), and enabling the user to alter configurable acronym expansion settings (not shown).

Numerous mechanisms can be used to trigger the appearance/disappearance of pop-up 250. In one embodiment, pop-up 250 can be a fly-over window. Accordingly, when a user places pointer 245 over either the acronym 240 and/or the expansion indicator 242, the pop-up 250 can automatically appear. When the cursor 245 is moved so that it is no longer over the acronym 240 or expansion indicator 242, the pop-up 250 can automatically disappear. A time-out condition can be established, where the pop-up only appears if pointer 245 remains stationary over acronym 240 or expansion indicator 242 for a previously determined time.

The invention is not limited to a fly-over activation mechanism, however, and any mechanisms known in the field of computer technology can be utilized. For example, mouse clicking on the indicator 242 can cause pop-up 250 to appear. Clicking on pop-up 250 or on a closing icon within pop-up 250 (not shown) can cause pop-up 250 to disappear. In another embodiment, a key press combination, such as a hot key, can cause a pop-up 250 for the most recently displayed acronym 240 to appear/disappear. In yet another embodiment, when a new acronym appears in dialog section 220, pop-up 250 can automatically be displayed for an established time, such as two seconds, and can then automatically disappear.

It should be appreciated that although GUI 200 illustrates an online communication application 210, the invention is not to be construed as limited in this manner. That is, the use of pop-ups for acronym expansion can be utilized in the context of any GUI. For example, acronym expansion pop-ups can be a feature implemented within a Web browser to automatically expand acronyms contained within Web pages. In another example, a word processing application, document viewer, or electronic book viewer can include the acronym expansion feature described herein.

Additionally, although shown in a visual context, the acronym expansion feature shown in GUI 200 can be implemented for different modalities. For example, it may be difficult to display a legible pop-up expansion on a small screen of a mobile multimodal device, such as a smart phone, portable media player, or personal data assistant (PDA). To overcome this difficulty, the expansion can be audibly (and not visually) presented to a user responsive to a user selection of an associated acronym. The user selection can be made via a GUI, by selecting a specialized button on the mobile device, by speaking an audio command, and the like.

In another embodiment, an acronym expansion feature can be included in an audio only interface, such as a telephone interface used by users when interfacing with an interactive voice response system (IVR). A user hearing an unknown acronym, which may be speech output transcoded from a text-based source, can select to pause a speech stream (by pressing a keypad button or speaking a triggering phrase) and to hear an expansion for the acronym. After the expansion is audibly presented, the interrupted speech stream can resume. Moreover, a user configurable option can permit a user to have all acronyms that have matching expansions within an acronym expansion repository automatically replaced with their equivalent expansions when text including the acronyms is audibly rendered.

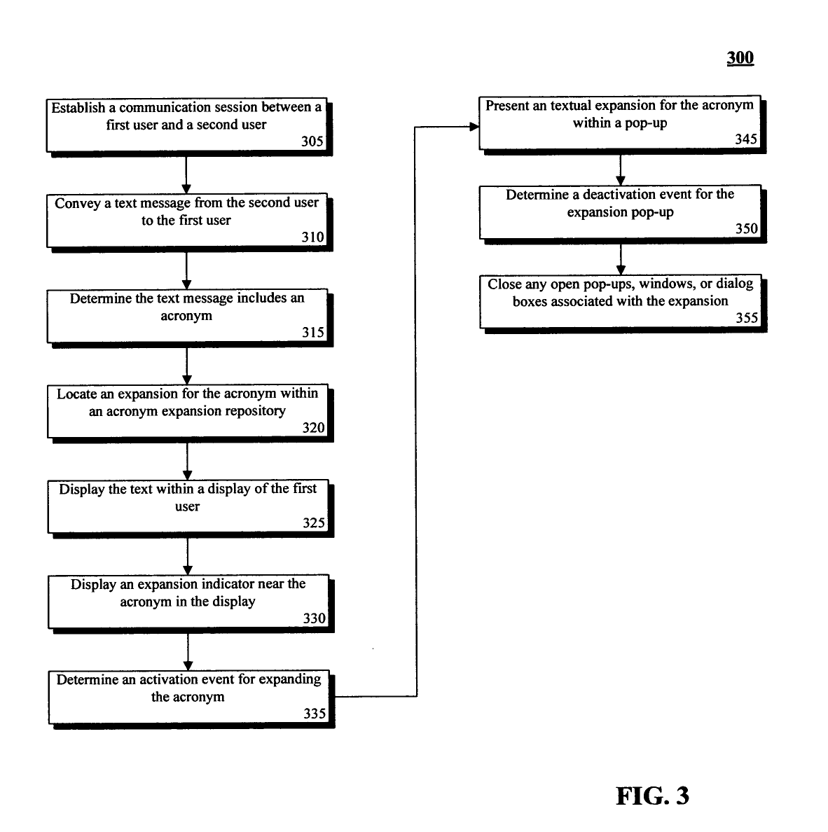

FIG. 3 is a flow chart of a method 300 for automatically defining acronyms in accordance with an embodiment of the inventive arrangements disclosed herein. Method 300 can be performed in the context of any system or interface that utilizes pop-ups to expand acronyms. For example, method 300 can be performed in the context of system 100 and/or GUI 200.

Method 300 can begin in step 305, where a communication session can be established between a first user and a second user. The communication session can be a direct communication between the two users or can be facilitated via a communication server, such as a chat server. Additional users can also participate within the communication session. In step 310, a text message can be conveyed from the second user to the first user.

In step 315, it can be determined that the text message includes an acronym to be expanded. In making this determination, a text processor can compare individual works and text strings against one or more tables of previously text strings that contain a list of defined acronyms and corresponding expansions. This list can be a user configurable list generally referred to herein as an acronym expansion repository. Different repositories exist, which can be combined. For example, the first user, the second user, and the chat server can each maintain an acronym expansion repository.

In step 320, an expansion for the acronym can be located from within an acronym expansion repository. This step can occur within a machine of the first user after a text message is received, at a machine of the second user before the text message is sent, or at an intermediary communication server between message reception and transmission. In step 325, the text can be displayed within a display of the first user. In step 330, an expansion indicator can be displayed near the acronym in the display.

In step 335, an activation event for expanding the displayed acronym can be determined. For example, a user could move a pointer over the displayed acronym, which results in a display of a fly-over window containing the expansion. In step 345, a textual expansion for the acronym can be displayed within a pop-up. In step 350, a deactivation event can be determined for the expansion pop-up. For example, a user could move a pointer from a position over the acronym to a different position. Time delay criteria can be established for the activation and/or deactivation events. Additionally, the deactivation even can occur automatically after the pop-up has been displayed for a user or system defined time. In step 355, any open pop-up associated with the expansion can be closed.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for automatically defining acronyms comprising:
a user receiving an electronic communication, wherein the electronic communication includes text, wherein the text includes at least one acronym;
displaying the text within a graphical user interface (GUI) viewable by the user;
detecting a positioning of a pointer proximate to the displayed acronym; and
automatically presenting a pop-up, wherein the pop-up includes an expansion of the displayed acronym.

2. The method of claim 1, wherein the electronic communication is an online communication between at least two human participants, wherein said online communication permits the exchange of text messages.

3. The method of claim 2, wherein the online communication is a real-time interactive communication.

4. The method of claim 3, wherein the real-time interactive communication includes at least one of a chat communication and an instant messaging communication.

5. The method of claim 1, wherein the electronic communication includes an e-mail communication.

6. The method of claim 1, further comprising:
displaying a visual indicator for the acronym, wherein the visual indicator indicates that an expansion for the acronym is available.

7. The method of claim 6, wherein the visual indicator is displayed when the pop-up is displayed and when the pop-up is not displayed.

8. The method of claim 1, wherein the pop-up is a fly-over popup activated and deactivated by a position of the pointer.

9. The method of claim 1, wherein the graphical user interface is a multimodal interface, and wherein the presenting step is configured to audibly present the expansion.

10. The method of claim 1, further comprising:
providing a user customizable acronym expansion repository, wherein the expansion displayed in the pop-up is retrieved from the acronym expansion repository.

11. The method of claim 1, wherein the user customizable acronym expansion repository from which the expansion is received is associated with a communication participant other than the user.

12. The method of claim 1, wherein the user is a first participant in a communication session that includes a second participant, said method further comprising:
identifying a first acronym expansion repository associated with the first participant; and
identifying a second acronym expansion repository associated with the second participant, wherein the displayed acronym is included in the first acronym expansion repository and in the second acronym expansion repository, wherein the expansion presented in the pop-up is obtained from the second acronym expansion repository.

13. A system for exchanging text messages comprising:
a communication server that manages communication sessions between remotely located communication participants, wherein the communication sessions are configured to permit an exchange of text messages;
an acronym expansion repository including a plurality of acronyms and corresponding expansions;
a message processing engine configured to automatically detect when acronyms included within the acronym expansion repository are included within text messages; and
a communication interface used by one of the communication participants, said communication interface including a participant activatable option for automatically presenting an expansion from the acronym expansion repository for an acronym textually displayed within the communication interface.

14. The system of claim 13, wherein the communication participant is able to add new acronyms and expansions to the acronym expansion repository via the communication interface.

15. The system of claim 13, wherein the communication server includes the message processing engine, and wherein the communication server adds expansion indicators to messages, which indicate that an acronym included in the messages has an associated expansion, which the communication interface is configured to selectively present.

16. A graphical user display (GUI) in which acronym expansions are presented comprising:
an application window including a text display area, wherein at least one acronym is displayed in the text display area;
an expansion indicator displayed in the text display area proximately positioned to the acronym, wherein presence of the expansion indicator indicates to a user that an expansion is available for the acronym; and
a pop-up displayed on top of the application window, wherein the pop-up displays an expansion for the acronym.

17. The GUI of claim 16, wherein the pop-up display is a fly-over display selectively displayed based upon a pointer position.

18. The GUI of claim 16, wherein the application window is a window of an online communication program within which communication participants exchange text based messages.

19. The GUI of claim 18, wherein the expansion displayed in the pop-up is a user defined expansion, which has been previously defined in an acronym expansion repository by a communication participant other than the user.

20. The GUI of claim 16, further comprising:
an acronym definition interface configured to permit the user to establish user defined acronyms and associated expansions, wherein the user defined acronyms are automatically detected when present in the text display area, which results in a display of an expansion indicator for the displayed user defined acronym.
